(19) United States
(12) Patent Application Publication
(10) Pub. No.: US 2008/0304831 A1
(43) Pub. Date: Dec. 11, 2008

(54) Mesh free-space optical system for wireless local area network backhaul

(76) Inventors: Robert Raymond Miller, II, Convent Station, NJ (US); David Michael Britz, Rumson, NJ (US)

Correspondence Address: AT&T CORP., ROOM 2A207, ONE AT&T WAY, BEDMINSTER, NJ, 07921, US

(21) Appl. No.: 12/148,182

(22) Filed: Apr. 17, 2008

Related U.S. Application Data
(60) Provisional application No. 60/933,765, filed on Jun. 8, 2007.

(51) Int. Cl. H04B 10/00

(52) U.S. Cl. 398/115

(57) ABSTRACT

In wireless local area networks (WLANS) with a large number of access points, the provisioning and capacity of the WLAN backhaul network connecting the access points to a core network becomes a major issue in network design. Some network services call for access points to be deployed in high densities in a wide range of environments, including outdoor environments. Traditional backhaul networks using fixed media such as twisted pair cable, coax cable, or optical fiber, in many instances are not physically or economically viable. Disclosed are method and apparatus for connecting access points via a mesh network using free-space optical links. The free-space optical links may be supplemented with mm-wave links to increase reliability and capacity.

This application claims the benefit of U.S. Provisional Application No. 60/933,765 filed Jun. 8, 2007, which is incorporated herein by reference.

### BACKGROUND OF THE INVENTION

The present invention relates generally to wireless networks, and more particularly to mesh free-space optical systems for wireless backhaul networks.

Popular communications services such as access to the global Internet, e-mail, and file downloads, are provided via connections to packet data networks. To date, user devices such as personal computers have commonly connected to a packet data network via a wired infrastructure. For example, a patch cable connects the Ethernet port on a personal computer to an Ethernet wall jack, which is connected by infrastructure cabling running through the walls of a building to network equipment such as a switch or router. There are disadvantages to a wired infrastructure. From a network perspective, providing packet data services to homes and commercial buildings requires installation of infrastructure cabling. From a user perspective, access to the network is limited to availability of a wall jack, and the length of the patch cable limits mobility.

Wireless local area networks (WLANs) provide advantages both for network provisioning and for customer services. For a network provider, a WLAN reduces required runs of infrastructure cabling. For a network user, a WLAN provides ready access for mobile devices such as laptop computers and personal digital assistants. WLANs are widely deployed in residences, businesses, airports, and campuses. They have become commonplace in coffee shops, waiting rooms, and Internet cafes. The WLAN interface to a wireless user device (such as a laptop outfitted with a wireless modem) is commonly an access point, a radio-frequency (RF) transceiver. The user device communicates with the access point, which then is typically connected to a packet data network via a fixed-line network connection. The user then accesses services via the packet data network.

Homes are typically served by a single access point, which is connected to an Internet Service Provider (ISP) via a broadband connection such as digital subscriber line (DSL) or cable. In a larger complex, such as a campus, multiple access points are needed to provide adequate coverage. The multiple access points are then typically connected to a common fixed-line local area network, such as an Ethernet local area network (LAN), which is connected to a core packet data network. The network that connects access points to a core packet data network is referred to as a backhaul network.

WLANs may be configured via various network schemes. Some are proprietary, and some follow industry standards. At present, many widely deployed WLANs follow the IEEE 802.11 standard. WLANs based on these standards are popularly referred to as Wi-Fi. Wi-Fi networks are now extending beyond local area networks to wide area networks covering neighborhoods and entire municipalities, sometimes competing with cellular packet data services. With proper network design, the required transmitter power for a user device may be lower for a Wi-Fi network than for a cellular network. Lower power requirements permit user devices with smaller size and longer battery life while preserving the ability to provide broadband (Ethernet-like) connectivity. In some instances, Wi-Fi access may be less expensive than cellular access.

In a Wi-Fi network with a small number of access points, throughput is commonly limited by the capacity of the RF links rather than the capacity of the backhaul network. Systems such as a 4G (Fourth Generation) Neighborhood Area Network (NAN), however, may include ˜100-300 access points. Each access point provides a service coverage area of ˜300 meters. With such an extensive WLAN, the backhaul network may become a major factor in WLAN deployment. Additionally, some services call for access points to be installed outdoors, for example, mounted on utility poles. Providing backhaul network connections via fixed-line physical media such as twisted pair cable, coax cable, or optical fiber may be difficult and expensive. In some instances, they may not be a viable option (for example, if requisite right-of-way cannot be obtained).

It is therefore advantageous in many instances for backhaul communication links to be wireless. For example, in addition to RF links, wireless communication links include mm-wave links (that is, electromagnetic radiation with wavelengths on the order of millimeters). Wireless communication links also include free-space optical communications (FSOC) links.

What is needed is a wireless backhaul network that provides high capacity, has a flexible architecture to accommodate a wide range of network geometries under a wide range of environmental conditions, and reduces cost of installation.

### BRIEF SUMMARY OF THE INVENTION

Wireless local area network (WLAN) access points are typically connected to a core network via a WLAN backhaul network with fixed-line infrastructure such as twisted-pair cable, coax cable, or optical fiber. As the number of access points in a WLAN increases, and as they are deployed in a wide range of environments (including outdoors), the capacity and provisioning of the WLAN backhaul network becomes increasingly important. Embodiments of the invention connect the access points via free-space optical links, which do not require installation of physical media between access points. A WLAN backhaul network with a mesh topology provides increased network reliability through path redundancy. Supplementing the free-space optical links with millimeter wave (mm-wave) links provides increased network reliability through modal redundancy.

These and other advantages of the invention will be apparent to those of ordinary skill in the art by reference to the following detailed description and the accompanying drawings.

### BRIEF DESCRIPTION OF THE DRAWINGS

FIG. 1 shows a high-level schematic of a wireless local area network, backhaul network, and core network.

FIG. 2 shows a high-level schematic of a multi-mode access point.

FIG. 3 shows a high-level schematic of a free-space optical backhaul network with a star topology.

FIG. 4 shows a high-level schematic of a redundant muti-mode backhaul network with a full mesh topology.

FIG. 5 shows a high-level schematic of a wide area wireless network formed by multiple wireless local area networks.

### DETAILED DESCRIPTION

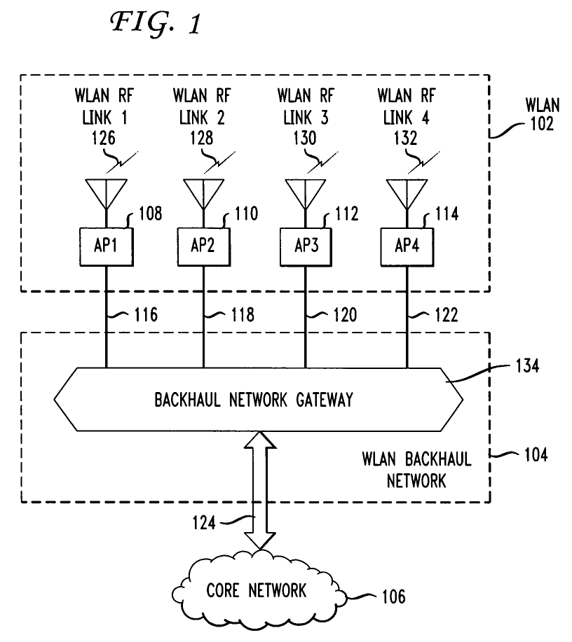

FIG. 1 shows a high-level schematic of a packet data network including WLAN 102, WLAN backhaul network 104, and core network 106. Herein, a Wi-Fi network complying with the IEEE 802.11 standard is used as an example of a WLAN. Embodiments of the invention, however, apply to other WLANs as well and are not restricted to Wi-Fi networks. WLAN 102 includes four access points AP1 108-AP4 114, with WLAN RF communication links WLAN RF link 1 126-WLAN RF link 4 132, respectively. Backhaul communication links 116-122 connect access points AP1 108-AP4 114 to backhaul network gateway 134, respectively. For simplicity, herein, a backhaul network gateway is referred to as a gateway. Communication link 124 connects gateway 134 to core network 106. In some instances, communication link 124 connects gateway 134 to an intermediate access network, such as an edge network, which then connects to a core network. Herein, WLAN backhaul network 104 includes the combined set of backhaul communication links 116-122 and gateway 134. For simplicity, herein, a WLAN backhaul network is referred to as a backhaul network. In some backhaul networks, there may be more than one gateway. One example of backhaul network 104 is an Ethernet network. Backhaul communication links 116-122 are twisted pair cables. Gateway 134 is an Ethernet switch/router.

As discussed above, fixed-line physical media, such as twisted-pair cable, coax cable, and optical fiber, have strong disadvantages for general deployment. It is therefore advantageous for backhaul communication links 116-122 to be wireless. Herein, a communication link is wireless if it does not require physical media for signal transport. For example, wireless communication links include VHF/UHF/SHF links, mm-wave links, and links transmitting over other ranges of the electromagnetic spectrum (e.g. Terahertz). Wireless communication links also include free-space optical communication (FSOC) links, in which the physical links are optical beams, typically laser beams.

For example, backhaul communication links 116-122 may themselves be WLAN RF links. If backhaul communication links 116-122 share the same spectrum as WLAN RF link 1 126-WLAN RF link 4 132, however, there is a high probability of co-channel interference, resulting in reduced overall network throughput. If a communication link transmits signals in a frequency range that may cause co-channel interference with signals in the WLAN RF frequency range, the frequency range of the communication link is referred to herein as in-band. The in-band frequency range may be the same as, overlap, or be adjacent to the WLAN RF frequency range. If a communication link transmits signals in a frequency range that does not cause co-channel interference with signals in the WLAN RF frequency range, the frequency range of the communication link is referred to herein as out-of-band.

In an embodiment of the invention, an access point includes a WLAN RF transceiver (XCVR) and an out-of-band XCVR. In general, a XCVR refers to a transmitter/receiver pair. In some instances, however, a radio link may have capability for transmission only. In other instances, a XCVR may have the capability to receive only. Herein, XCVR refers to all three combinations: transmitter only, receiver only, and transmitter/receiver pair. An access point including a WLAN RF XCVR and an out-of-band XCVR is referred to herein as a multi-mode access point. The WLAN RF XCVR and an out-of-band XCVR communicate with each other. A WLAN RF XCVR and an out-of-band XCVR may be integrated into a single unit. In general, however, a WLAN RF XCVR and an out-of-band XCVR may be separate units that may communicate with each other via a wired or wireless link. Herein, a WLAN RF XCVR and an out-of-band XCVR are connected if they may communicate (that is, exchange information) with each other.

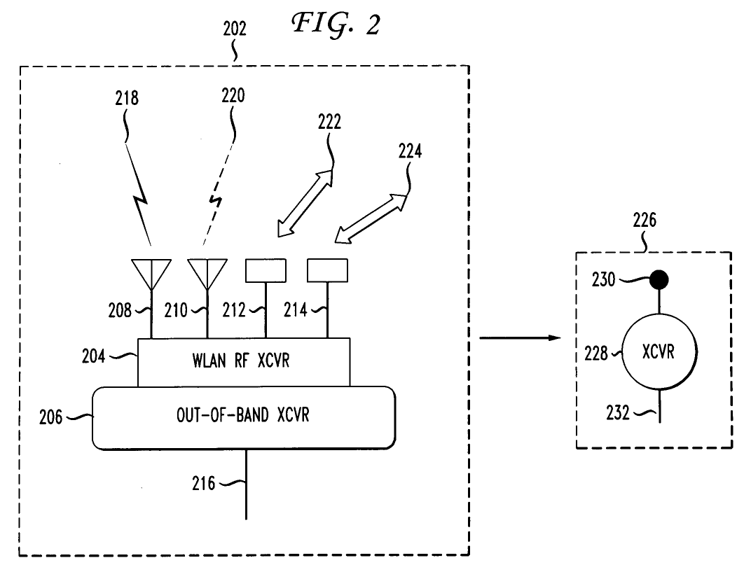

An example of a multi-mode access point is shown in FIG. 2. Multi-mode access point 202 includes WLAN RF XCVR 204 and out-of-band XCVR 206. Also shown are antenna 208, antenna 210, optical source/photo-detector 212, and optical source/photo-detector 214. Fixed-line 216 may be used for some network connections. In general, there may be multiple fixed-line connections. Fixed-line 216 may be twisted-pair cable, coax cable, or optical fiber, for example. Signal 218 represents a WLAN RF signal. Signal 220 represents a mm-wave signal. Signal 222 and signal 224 represent optical signals. In general, a multi-mode access point may include multiple WLAN RF XCVRs and multiple out-of-band XCVRs. For example, multi-mode access point 202 may include three mm-wave (or other out-of-band frequency) XCVRs and two optical XCVRs. In general, out-of-band XCVR 206 may operate over multiple frequencies/multiple wavelengths. Optical sources in optical source/photo-detectors 212 and 214 are commonly lasers, but may also be other optical sources such as light-emitting diodes (LEDs). For simplicity, a multi-mode access point is represented by multi-mode access point 226. The combined set of WLAN and out-of-band XCVRs is represented by XCVR 228. The combined set of antennas and optical sources/photo-detectors is represented by transducer 230. The combined set of fixed-line connections is represented by fixed-line connection 232.

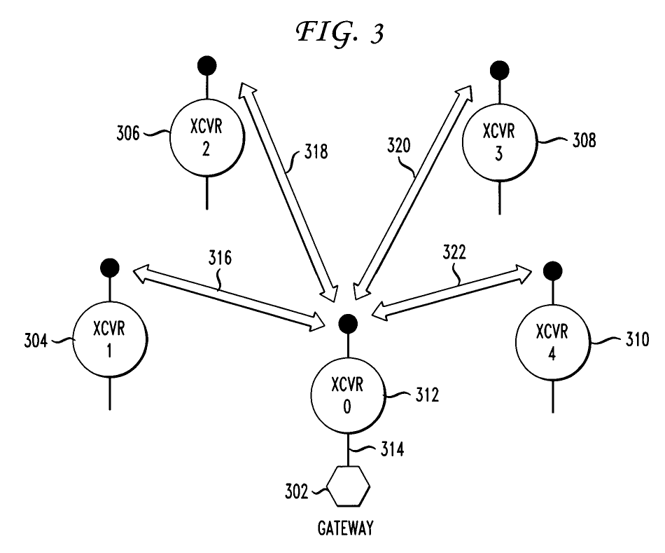

FIG. 3 shows a high-level architecture of a backhaul network with a star topology. In this example, multi-mode access point 312 serves as a hub connected to gateway 302 via fixed-line connection 314. Multi-mode access points 304-310 are remotely distributed, and communicate with multi-mode access point 312 via backhaul communication links 316-322, respectively. In this example, backhaul communication links 316-322 are free-space optical links.

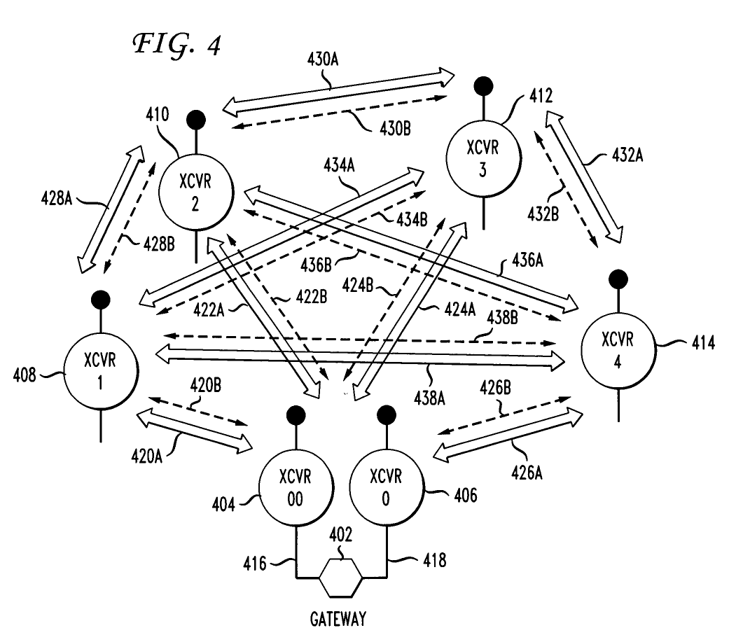

FIG. 4 shows a high-level architecture of a network with a full-mesh topology. In this example, the network has both path and modal redundancy (modal redundancy is discussed further below). Redundancy may be used for either higher reliability or higher capacity (or an intermediate combination of both). In a network, there is path redundancy if two network nodes are connected by more than one path, such that, if one path fails, the two nodes may still communicate via an alternate path. Herein, a node refers to an arbitrary connection point (virtual or physical) in a network. Examples of physical nodes include access points and gateways. A path includes one or more communication links. In the example shown in FIG. 4, multi-mode access points 404 and 406 serve as hubs connected to gateway 402 via fixed-line communication link 416 and fixed-line communication link 418, respectively. Multi-mode access points 408-414 are remotely distributed. Multi-mode access points 404-414 are connected in a full-mesh topology. That is, any particular multi-mode access point is connected to every other multi-mode access point via a point-to-point link. Multi-mode access points 408-414 are interconnected via backhaul communication links 420A/B-438A/B. The A/B designator is discussed below in reference to modal redundancy.

Consider connectivity between multi-mode access point 408 and multi-mode access point 404. The most direct path between the two is the single point-to-point backhaul communication link 420A/B. If that link were to fail, then multi-mode access point 408 may still communicate with multi-mode access point 404 via the path formed by the combination of backhaul communication link 428A/B connecting multi-mode access point 408 with multi-mode access point 410 and backhaul communication link 422A/B connecting multi-mode access point 410 with multi-mode access point 404. This path, in conjunction with backhaul communication link 420A/B, may be also used without redundancy to provide additional traffic capacity between multi-mode access point 408 and multi-mode access point 404.

In FIG. 4, subsets of the full-mesh topology may be used to illustrate other topologies. For example, backhaul communication links 42Q A/B-426A/B connect multi-mode access points 408-414 to multi-mode access points 404 and 406 in a star topology (same as in FIG. 3). Backhaul communication links 420 A/B and 426A/B-432 A/B connect multi-mode access points 404-414 in a ring topology. A network topology may also be partial mesh. For example, consider a sub-network including only multi-mode access points 404-412 and backhaul communication links 420A/B, 428A/B, 422A/B, and 430A/B. Then multi-mode access points 404-410 are connected in a full mesh (that is, there is a point-to-point link between any two multi-mode access points). Multi-mode access point 412, however, is connected only to multi-mode access port 410 via backhaul communication link 430A/B. Multi-mode access point 412 can connect to multi-mode access points 404-408 only indirectly via multi-mode access point 410. If either backhaul communication link 430A/B or multi-mode access point 410 were to fail, multi-mode access point 412 would not be able to communicate with multi-mode access points 404-408. Herein, a mesh network refers to either a full mesh network or a partial mesh network.

Signals from various portions of the electromagnetic spectrum may be used for backhaul networks. Mm-waves may be used. They are, however, subject to interference, especially when the multi-mode access points are densely clustered. Signal transmission is also degraded by heavy rain. Free-space optical links may be used for communication links. Signal transmission, however, is degraded by fog. For a backhaul network, however, free-space optical links are advantageous. Over short distances, signal degradation by fog is less likely than over long distances. With densely clustered multi-mode access points, free-space optical links do not have the interference problems that mm-wave links do. Therefore, free-space optical links by themselves are well suited for backhaul networks.

In a network, a link has modal redundancy if two nodes are connected by more than one transmission mode. For example, two nodes may be connected by an RF link and a microwave link. In an advantageous embodiment, modal redundancy for a mesh backhaul network is provided by a combination of a free-space optical link and a mm-wave link. In the network shown in FIG. 4, multi-mode access points 404-414 are interconnected by backhaul communication links 420A/B-438 A/B. In this example, the A-link is a free-space optical link, and the B-link is a mm-wave link. Since heavy rain and dense fog tend not to occur simultaneously, the combination of a free-space optical link and a mm-wave link provide good signal transmission over a wide range of weather conditions. In addition to operating in a fail-over or backup mode, traffic may be run simultaneously over both the free-space optical link and the mm-wave link to increase capacity between two multi-mode access points.

Herein, multi-mode access points that communicate via free-space optical links communicate via a free-space optical network. Herein, multi-mode access points that communicate via mm-wave links communicate via a mm-wave network. In general, herein, multi-mode access points that communicate via out-of-band links communicate via an out-of-band network.

Note that additional redundancy may also be provided by installing redundant XCVRs operating in the same transmission mode. For example, two free-space optical transceivers may be installed in each multi-mode access point. If the optical beams from each optical transmitter in a multi-mode access point are sufficiently spaced far apart, such that each optical beam falls on a separate photo-detector on another multi-mode access point, they may transmit simultaneously. Alternatively, optical beams with different wavelengths may be used.

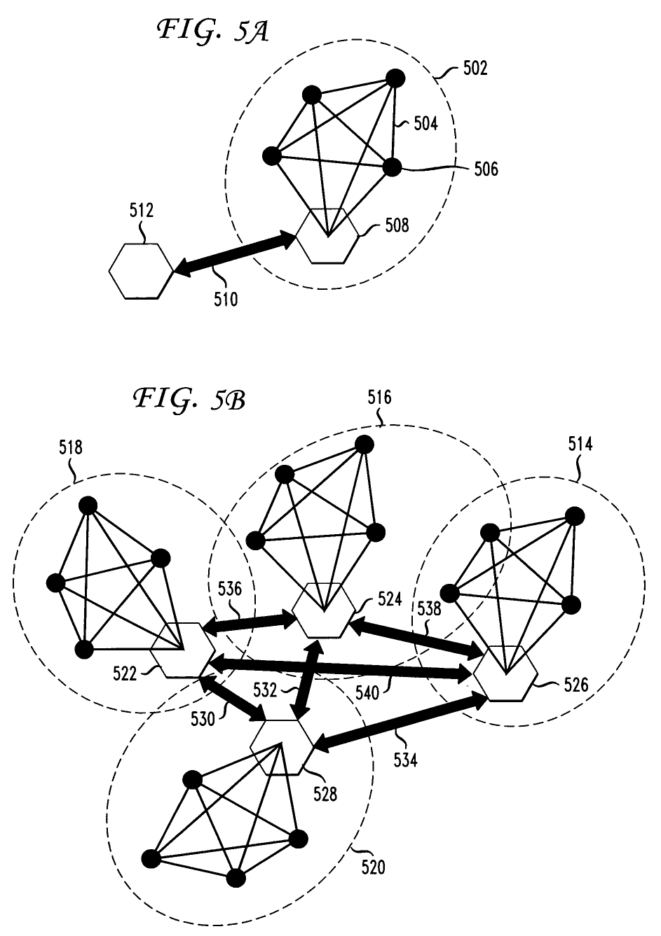

FIG. 5A and FIG. 5B show a high-level architecture of an extended network composed of multiple local full-mesh networks. FIG. 5A shows a high-level schematic of single full-mesh network 502. Filled circle 506 represents a multi-mode access point. Hexagon 508 represents a gateway. Line 504 represents a backhaul communication link (which may have modal redundancy). Bus 510 represents a backbone trunk between gateway 508 and gateway 512 (for example, a gateway which belongs to another full-mesh network, an edge access network, or a core network).

FIG. 5B shows a high-level schematic of four local full-mesh networks 514-520, connected together to form an extended (wide area) network. Note that the coverage areas of local full-mesh networks 514-520 overlap, thus permitting a user to seamlessly roam (for example, via hand-offs) from one coverage area to another. Local full-mesh networks 514-520 are themselves interconnected in a full-mesh topology. Gateways 522-528 are interconnected in a full-mesh topology via backbone trunks 530-540.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A backhaul network comprising:
a plurality of multi-mode access points, each comprising:
a wireless local area network (WLAN) radio-frequency (RF) transceiver; and
a free-space optical transceiver connected to said WLAN RF transceiver and configured to communicate with at least one other free-space optical transceiver in said backhaul network.

2. The backhaul network of claim 1, wherein the plurality of multi-mode access points are configured in a free-space optical network with a mesh topology.

3. The backhaul network of claim 1, wherein each of said multi-mode access points further comprises a millimeter-wave (mm-wave) transceiver.

4. The backhaul network of claim 3, wherein the plurality of multi-mode access points are configured in a mm-wave network with a mesh topology.

5. The backhaul network of claim 1, wherein each of said multi-mode access points further comprises an out-of-band transceiver.

6. The backhaul network of claim 5, wherein the plurality of multi-mode access points are configured in an out-of-band network with a mesh topology.

7. The backhaul network of claim 1, wherein each of said multi-mode access points further comprises a mm-wave transceiver and an out-of-band transceiver.

8. The backhaul network of claim 7, wherein the plurality of multi-mode access points are configured in a mm-wave network with a mesh topology and an out-of-band network with a mesh topology.

9. A method for operating at least one of a plurality of multi-mode access points, each comprising a WLAN transceiver and a free-space optical transceiver, said plurality of multi-mode access points configured in a free-space optical network with a mesh topology, comprising the steps of:
receiving at least one RF signal at a first multi-mode access point; and
transmitting from said first multi-mode access point at least one free-space optical signal based at least in part on said received at least one RF signal.

10. The method of claim 9, wherein each of said multi-mode access points further comprises a mm-wave transceiver, said plurality of multi-mode access points further configured in a mm-wave network with a mesh topology.

11. The method of claim 10, further comprising the steps of:
receiving at least one RF signal at a second multi-mode access point; and
transmitting from said second multi-mode access point at least one mm-wave signal based at least in part on said received at least one RF signal.

12. The method of claim 10, further comprising the steps of:
receiving at least one mm-wave signal at a second multi-mode access point; and
transmitting from said second multi-mode access point at least one RF signal based at least in part on said received at least one mm-wave signal.

13. The method of claim 9, wherein each of said multi-mode access points further comprises an out-of-band transceiver, said plurality of multi-mode access points further configured in an out-of-band network with a mesh topology.

14. The method of claim 13, further comprising the steps of:
receiving at least one RF signal at a second multi-mode access point; and
transmitting from said second multi-mode access point at least one out-of-band signal based at least in part on said received at least one RF signal.

15. The method of claim 13, further comprising the steps of:
receiving at least one out-of-band signal at a second multi-mode access point; and
transmitting from said second multi-mode access point at least one RF signal based at least in part on said received at least one out-of-band signal.

16. A method for operating at least one of a plurality of multi-mode access points, each comprising a WLAN transceiver and a free-space optical transceiver, said plurality of multi-mode access points configured in a free-space optical network with a mesh topology, comprising the steps of:
receiving at least one free-space optical signal at a first multi-mode access point; and
transmitting from said first multi-mode access point at least one RF signal based at least in part on said received at least one free-space optical signal.

17. The method of claim 16, wherein each of said multi-mode access points further comprises a mm-wave transceiver, said plurality of multi-mode access points further configured in a mm-wave network with a mesh topology.

18. The method of claim 17, further comprising the steps of:
receiving at least one RF signal at a second multi-mode access point; and
transmitting from said second multi-mode access point at least one mm-wave signal based at least in part on said received at least one RF signal.

19. The method of claim 17, further comprising the steps of:
receiving at least one mm-wave signal at a second multi-mode access point; and
transmitting from said second multi-mode access point at least one RF signal based at least in part on said received at least one mm-wave signal.

20. The method of claim 16, wherein each of said multi-mode access points further comprises an out-of-band transceiver, said plurality of multi-mode access points further configured in an out-of-band network with a mesh topology.

21. The method of claim 20, further comprising the steps of:
receiving at least one RF signal at a second multi-mode access point; and
transmitting from said second multi-mode access point at least one out-of-band signal based at least in part on said received at least one RF signal.

22. The method of claim 20, further comprising the steps of:
receiving at least one out-of-band signal at a second multi-mode access point; and,
transmitting from said second multi-mode access point at least one RF signal based at least in part on said received at least one out-of-band signal.
